(19) United States
(12) Patent Application Publication
(10) Pub. No.: US 2023/0402665 A1
(43) Pub. Date: Dec. 14, 2023

(54) SOLAR CHARGING USING ADJUSTABLE SECONDARY BATTERY

(71) Applicant: GM GLOBAL TECHNOLOGY OPERATIONS LLC, DETROIT, MI (US)

(72) Inventors: Taeyoung Han, Troy, MI (US); Jun-mo Kang, Ann Arbor, MI (US); Shyh-yeu Jao, Bloomfield Hills, MI (US); Susan Carol Ellis, Hampton (CA); Valerie Sue Malaney, West Bloomfield, MI (US)

(21) Appl. No.: 17/839,823

(22) Filed: Jun. 14, 2022

(51) Int. Cl. H01M 10/46; H02J 7/00; B60L 53/22

(52) U.S. Cl. CPC H01M 10/465; H02J 7/0048; H02J 7/007182; B60L 53/22

(57) ABSTRACT

A solar energy charging system of a vehicle includes a dynamically adjustable battery (DAB) configured to be connected to a solar energy conversion device and charged by the solar energy conversion device. The DAB is controllable to adjust an output voltage of the DAB to one of a plurality of output voltages, and the DAB is configured to supply electrical power generated by the solar energy conversion device to a vehicle battery assembly. The solar energy charging system also includes a controller configured to detect an input voltage to the conversion device, select an output voltage of the DAB based on the input voltage, and control the DAB to provide the selected output voltage to a high voltage DC-DC converter to charge the battery assembly.

### INTRODUCTION

The subject disclosure relates to batteries and battery assemblies, and more particularly to charging batteries and battery assemblies using solar energy.

Vehicles, including gasoline and diesel power vehicles, as well as electric and hybrid electric vehicles, feature battery storage for purposes such as powering electric motors, electronics and other vehicle subsystems. Battery assemblies may be charged using dedicated charging stations and other power sources such as residences and building connected to a power grid. Solar energy can be employed to charge the batteries, for example, by installing solar panels on exterior vehicle components. Efficient use of solar energy can be challenging due to factors that include the variable nature of solar energy and voltage differences between solar panels and vehicle battery packs.

### SUMMARY

In one exemplary embodiment, a solar energy charging system of a vehicle includes a dynamically adjustable battery (DAB) configured to be connected to a solar energy conversion device and charged by the solar energy conversion device. The DAB is controllable to adjust an output voltage of the DAB to one of a plurality of output voltages, and the DAB is configured to supply electrical power generated by the solar energy conversion device to a vehicle battery assembly. The solar energy charging system also includes a controller configured to detect an input voltage to the solar energy conversion device, select an output voltage of the DAB based on the input voltage, and control the DAB to provide the selected output voltage to a high voltage DC-DC converter to charge the battery assembly.

In addition to one or more of the features described herein, the DAB includes a plurality of controllable switches, and the controller is configured to operate the switches to cause the DAB to output the selected voltage.

In addition to one or more of the features described herein, each voltage of the plurality of output voltages is less than a vehicle battery assembly voltage.

In addition to one or more of the features described herein, the system further includes a low voltage DC-DC converter configured to convert the input voltage to a low voltage value, where the controller is configured to select the output voltage based on the low voltage value.

In addition to one or more of the features described herein, the selected output voltage has a value that is closest to a value of the input voltage.

In addition to one or more of the features described herein, the controller is configured to measure a state of charge of the DAB, receive solar information indicative of a level of solar intensity, and select the output voltage based on the state of charge being below a threshold state of charge value and the level of solar intensity being at or above an intensity threshold value.

In addition to one or more of the features described herein, the solar information includes at least one of a measured input voltage from the solar energy conversion device, a measured solar intensity, and an estimated solar intensity derived from climate and weather information.

In addition to one or more of the features described herein, the controller is configured to measure a state of charge of the DAB, and receive solar information indicative of a level of solar intensity, and based on the state of charge being below a threshold state of charge value and the level of solar intensity being below an intensity threshold value, connect the DAB to the vehicle battery assembly to cause the vehicle battery assembly to charge the DAB.

In addition to one or more of the features described herein, the controller is configured to control the DAB to supply power to one or more additional vehicle components.

In another exemplary embodiment, a method of transferring charge includes connecting a dynamically adjustable battery (DAB) to a solar energy conversion device and to a vehicle battery assembly. The DAB is configured to be charged by the solar energy conversion device, and the DAB is controllable to adjust an output voltage of the DAB to one of a plurality of output voltages. The method also includes detecting, by a controller, an input voltage to the solar energy conversion device, selecting an output voltage of the DAB based on the input voltage, and controlling the DAB to provide the selected output voltage to a high voltage DC-DC converter to charge the battery assembly.

In addition to one or more of the features described herein, each voltage of the plurality of output voltages is less than a vehicle battery assembly voltage.

In addition to one or more of the features described herein, the method further includes supplying charge to the DAB from the solar energy conversion device.

In addition to one or more of the features described herein, supplying the charge includes converting the input voltage by a low voltage DC-DC converter to a low voltage value, and the output voltage is selected based on the low voltage value.

In addition to one or more of the features described herein, the selected output voltage has a value that is closest to a value of the input voltage.

In addition to one or more of the features described herein, the method further includes measuring a state of charge of the DAB and receiving solar information indicative of a level of solar intensity, where the output voltage is selected based on the state of charge being below a threshold state of charge value and the level of solar intensity being at or above an intensity threshold value.

In addition to one or more of the features described herein, the solar information includes at least one of a measured input voltage from the solar energy conversion device, a measured solar intensity, and an estimated solar intensity derived from climate and weather information.

In addition to one or more of the features described herein, the method further includes, based on the state of charge being below a threshold state of charge value and the level of solar intensity being below an intensity threshold value, connecting the DAB to the vehicle battery assembly and causing the vehicle battery assembly to charge the DAB.

In yet another exemplary embodiment, a vehicle system includes a solar energy conversion device, a battery assembly, and a solar energy charging system. The solar energy charging system includes a dynamically adjustable battery (DAB) configured to be connected to a solar energy conversion device and charged by the solar energy conversion device. The DAB is controllable to adjust an output voltage of the DAB to one of a plurality of output voltages, and the DAB is configured to supply electrical power generated by the solar energy conversion device to a vehicle battery assembly. The solar energy charging system also includes a controller configured to detect an input voltage to the solar energy conversion device, select an output voltage of the DAB based on the input voltage, and control the DAB to provide the selected output voltage to a high voltage DC-DC converter to charge the battery assembly.

In addition to one or more of the features described herein, the solar energy charging system further includes a low voltage DC-DC converter configured to convert the input voltage to a low voltage value, where the controller is configured to select the output voltage based on the low voltage value.

In addition to one or more of the features described herein, the selected output voltage has a value that is closest to a value of the input voltage.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a battery assembly and a solar energy charging system, in accordance with an exemplary embodiment;

FIG. 2 is a perspective view of the motor vehicle of FIG. 1, including an array of solar panels, in accordance with an exemplary embodiment;

FIG. 3 is a schematic diagram of a solar energy charging system including a secondary variable voltage battery, in accordance with an exemplary embodiment;

FIG. 4 depicts the solar energy charging system of FIG. 3 in a vehicle battery assembly charging mode, in accordance with an exemplary embodiment;

FIG. 5 depicts the solar energy charging system of FIGS. 3 and 4 in a secondary battery charging mode, in accordance with an exemplary embodiment;

FIG. 6 is a flow diagram depicting aspects of a method of transferring charge, in accordance with an exemplary embodiment;

FIG. 7 is a flow diagram depicting aspects of a method of transferring charge, in accordance with an exemplary embodiment;

FIGS. 8A-8C depict an example of a secondary variable battery in various operating states;

FIG. 9 is a graph illustrating efficiency and power loss characteristics; and

FIG. 10 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for transferring charge or energy to a vehicle battery assembly and/or other vehicle components from a solar energy conversion device. An embodiment of a solar energy charging system includes a secondary variable voltage battery having a configurable or selectable output voltage, referred to herein as a dynamically adjustable battery (DAB). The DAB is configured to be connected to the solar energy conversion device (e.g., one or more solar panels or panel arrays) and charged by the solar energy conversion device. The DAB is controllable to adjust the output voltage based on an input voltage from the conversion device to increase charging efficiency.

Embodiments described herein present numerous advantages and technical effects. For example, the embodiments provide for an efficient mechanism to charge a vehicle battery system using solar energy. Existing charging systems often include DC-DC converters. As there is often a large variation in solar intensity, there can be a significant mismatch between inputs to and outputs from a DC-DC converter, which can significantly impact the charging efficiency and lead to losses. Embodiments described herein address such challenges and increase the efficiency of solar energy charging systems.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use high voltage battery packs or other battery assemblies.

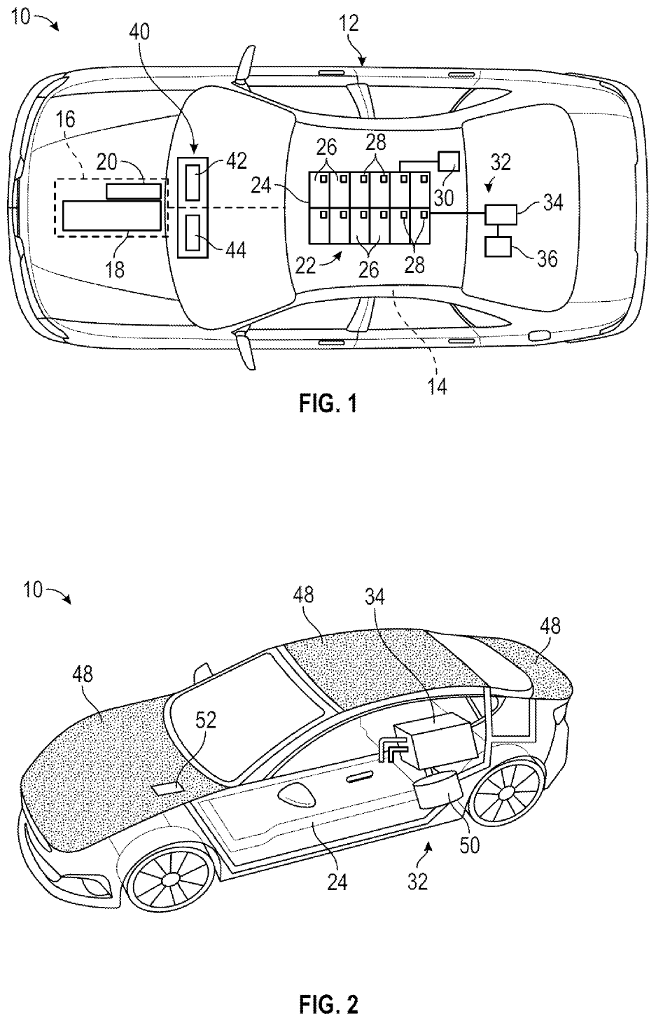

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid electric vehicle (HEV). In an example, the vehicle is a hybrid vehicle that includes a combustion engine assembly 18 and an electric motor assembly 20.

The vehicle 10 includes a battery system 22, which may be electrically connected to the motor assembly 20 and/or other components, such as vehicle electronics. In an embodiment, the battery system 22 includes a battery assembly such as a high voltage battery pack 24 having a plurality of battery modules 26. Each of the battery modules 26 includes a number of individual cells (not shown). The high voltage battery pack 24 is, for example, a 400 Volt (V) or 800 V battery pack.

In an embodiment, the battery assembly 22 is configured as a rechargeable energy storage system (RESS), and includes sensors 28 and a controller Each sensor 28 may be an assembly or system having one or more sensors for measuring various battery and environmental parameters, such as temperature, current and voltage. The controller 30 includes components such as a processor, memory, an interface, a bus and/or other suitable components.

The vehicle 10 also includes a solar energy charging system 32 configured for charging the battery pack 24 with energy from one or more solar energy conversion devices (not shown, see FIG. 2). The solar energy charging system 32 includes a dynamically adjustable battery (DAB) 34 that is configured to output at least two different voltages, and a controller 36 that controls the DAB 34 to output a selected voltage based on a voltage generated by the conversion devices. The DAB 34 includes, for example, a plurality of controllable switches can be operated to set output voltage levels. The switches may be of any suitable type, such as field effect transistors (FETs), metal-oxide-semiconductor FETs (MOSFETs) and power MOSFETs. The DAB 34 may have any number of switches to set to any number of different voltages.

The solar energy charging system 32 is configured to be directly charged by the conversion device(s), and is provided to increase efficiency and reduce power losses associated with solar energy charging. The DAB 34 can be adjusted to reduce a difference between a voltage generated by the solar energy conversion devices (“input voltage” or “solar panel voltage”) to reduce a difference between the input voltage and output voltage of a charging component or components, such as a DC-DC converter. The reduction increases charging efficiency and reduces the amount of hardware that would otherwise be needed to boost the solar panel voltage to battery pack levels.

The vehicle 10 also includes a computer system 40 that includes one or more processing devices 42 and a user interface 44. The various processing devices and units may communicate with one another via a communication device or system, such as a controller area network (CAN) or transmission control protocol (TCP) bus.

FIG. 2 depicts an example of the vehicle 10 and solar energy conversion devices. The conversion devices may be one or more arrays 48 of solar panels mounted at various locations. For example, a solar panel array 48 is mounted on the vehicle's roof, hood and rear section. In this example, the controller 36 and/or other components of the solar energy charging system 32 are disposed in a solar electronic control unit (solar ECU) 50 that is connected to the DAB 34.

The ECU 50, the controller 36, the DAB 34 and/or other components may be incorporated into one or more modules that can be installed in the vehicle 10 and removed as desired. For example, the ECU 50 and the DAB 34 are modules that can be removably connected to the battery system 22 and the solar panel arrays 48. Embodiments are not so limited and can be incorporated into the vehicle 10 in any suitable manner.

As discussed further herein, the controller 36 and/or ECU 50 is configured to adjust the output voltage of the DAB 34 based on a determined solar panel voltage. The solar panel voltage may be determined by directly detecting the solar panel voltage and providing a solar panel voltage value to the controller 36. Alternatively, or additionally, the solar panel voltage can be estimated based on solar intensity, which can be measured directly or estimated based on other information (e.g., the time of day and year, climate information, weather information, etc.). For example, a solar intensity or light sensor 52 may be mounted at one or more locations on the vehicle 10, such as on the front hood as shown in FIG. 2. The number, type and location of such sensors is not limited to the examples discussed herein.

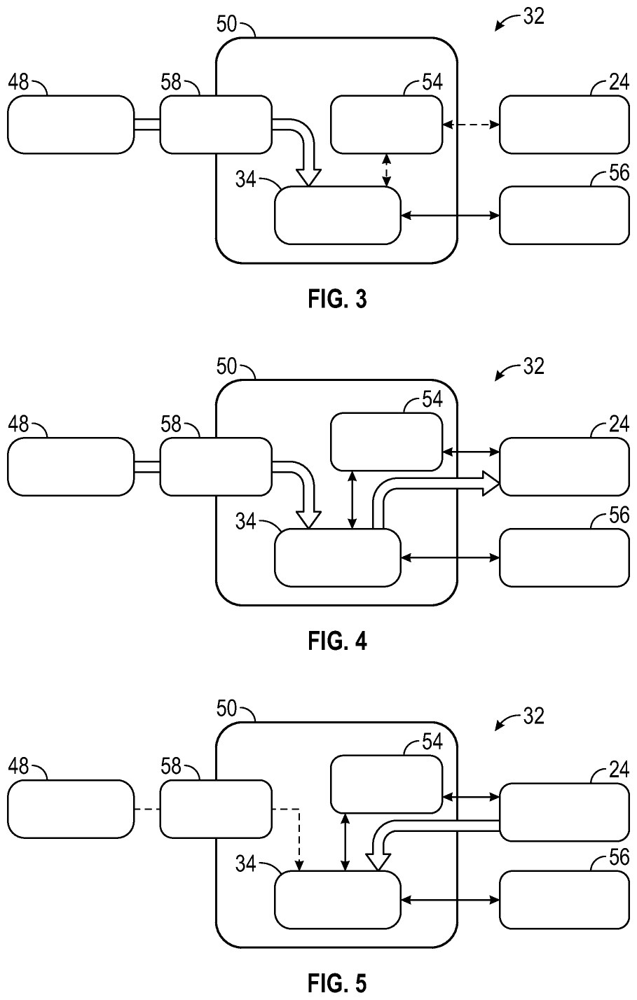

FIGS. 3-5 depict an embodiment of the solar energy charging system 32 in various operating modes. In this embodiment, the DAB 34 is housed with the ECU 50 and is connected to a high voltage DC-DC converter 54 configured to step up an output voltage of the DAB 34 to the battery pack voltage (e.g., 400V or 800V). The DAB 34 is also connected to other vehicle component(s) 56 for supplying power to such components (e.g., lighting, air conditioning, etc.).

The solar panel arrays 48 are connected to a low voltage DC-DC converter 58 that is configured to step up or step down the solar panel voltage to a selected voltage value. The selected voltage value may be based on the solar panel voltage. For example, the low voltage DC-DC converter 58 converts input voltages from the solar panel arrays 48 to 12V or 48V, depending on the input voltage levels.

FIG. 3 shows the charging system 32 in an operating mode in which the solar panel arrays 48 can charge the DAB 34 (referred to as a “secondary battery charging mode” or a “DAB charging mode”). The system 32 can be put in the DAB charging mode if the DAB state of charge (SOC) is below a threshold value and the solar panel arrays 48 are generating sufficient voltage (e.g., a minimum voltage such as 10V, or voltage within a selected range of the DC-DC converter 58). Charging can occur, for example, when the vehicle 10 is parked or driving in high solar energy conditions.

During charging, the low voltage DC-DC converter 58 steps input voltage up or down, and the DAB 34 is adjusted (e.g., by controlling switches) to select one of a plurality of voltage settings. In each voltage setting, the DAB 34 is configured to output one of a plurality of different output voltages. For example, the DAB 34 can have a 12V setting and a 24V setting. The voltage setting that is closest to the input voltage from the solar panel arrays 48 is selected. In this mode, the DAB is disconnected from the high voltage DC-DC converter 54 and from the battery pack 24.

FIG. 4 illustrates in an operating mode for charging the battery pack 24 (referred to as a “battery assembly charging mode” or a “battery pack charging mode”). The system 32 can be put in the battery pack charging mode if the DAB state of charge is at or above a selected charge level (e.g., 50%). In this mode, if the DAB 34 is fully charged (or above the selected charge level), the battery pack 24 and the high voltage DC-DC converter 54 are connected to the DAB 34. The DAB 34 outputs to the high voltage DC-DC converter 54, which steps up the voltage to the battery pack voltage. In this mode, the DAB 34 is connected to both the battery pack 24 and the solar panel arrays 48, and can be charged by the solar panels if conditions permit (i.e., sufficient light intensity is incident on the solar panels).

Referring to FIG. 5, if the state of charge of the DAB is low (below the selected charge level) and the solar panel arrays 48 are not outputting sufficient voltage, the system 32 can be put into a charging mode in which the battery pack 24 is used to charge the DAB 34. In this mode, the solar panel arrays 48 and the low voltage DC-DC converter 58 are disconnected from the DAB 34, and the battery pack 24 is connected to the DAB 34. The battery pack 24 outputs voltage to the high voltage DC-DC converter 54, which steps down the voltage and supplies power from the battery pack 24 to the DAB 34.

It is noted that the DAB 34 can be charged in other ways. For example, the DAB 34 can be selectively connected to the combustion engine assembly 18 or alternator (e.g., if the vehicle 10 is a HEV), or connected to a charge port and charged via a charging station or other power supply (e.g., residential outlet, power grid, etc.)

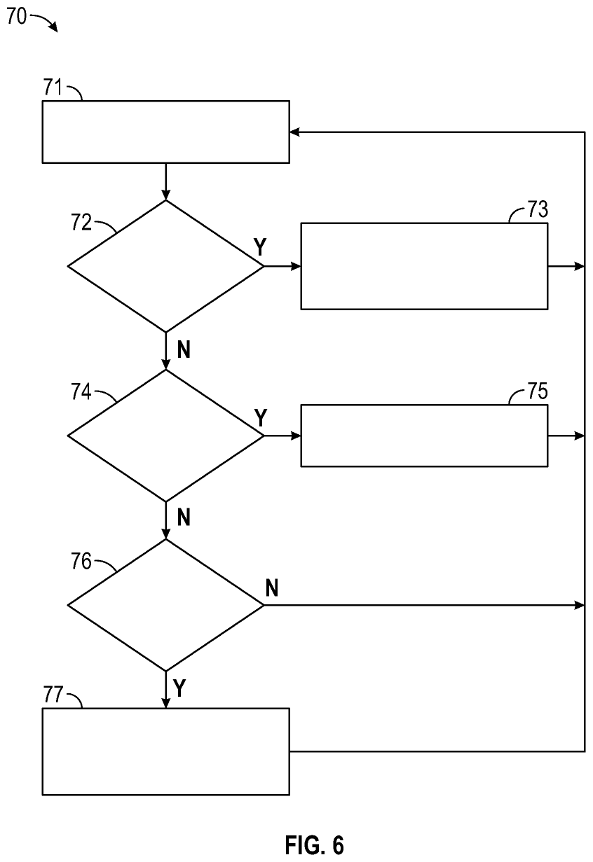

FIG. 6 illustrates embodiments of a method 70 of controlling transfer of charge between one or more vehicle systems or components. Aspects of the method 70 may be performed by a processor or processors disposed in a vehicle. For example, the method is discussed as being performed by the controller 36, but is not so limited, as the method 70 may be performed by the computer system or any other suitable processing device or system, or combination of processing devices (e.g., the ECU 50 or the computer system 40).

The method 70 includes a number of steps or stages represented by blocks 71-77. The method 70 is not limited to the number or order of steps therein, as some steps represented by blocks 71-77 may be performed in a different order than that described below, or fewer than all of the steps may be performed.

At block 71, parameters of the battery pack 24, the DAB 34 and the solar panel arrays 48 are monitored. For example, the battery pack 24 state of charge, and parameters including voltage and current of the solar panel arrays 48 are measured. In addition, parameters of the DAB 34, including state of charge and voltage setting, are determined. Additional parameters may be measured as desired. Measurements may be performed continuously, periodically or otherwise.

At block 72, the controller 36 determines whether the DAB 34 state of charge (SOC) is at or above a selected SOC threshold. If so, at block 73, the DAB 34 is put into the battery pack charging mode by connecting the DAB 34 to the battery pack 24, and charge is transferred to the battery pack 24 if needed or desired.

At block 74, if the DAB 34 SOC is below the SOC threshold, the controller 36 determines whether the output of the solar panels is sufficient for charging the DAB 34. This may be determined, for example, by measuring the solar panel voltage and current, and/or based on estimating solar intensity (e.g., via the sensor 52 or climate and weather information). The output from the solar panel arrays 48 is sufficient, for example, if the solar panel array voltage and/or solar intensity is at or above a respective threshold.

At block 75, if the solar panel array output is sufficient, the DAB 34 is put into the DAB charging mode and is charged by the solar panel arrays 48. The voltage setting of the DAB 34 is selected as the setting having a voltage that is closest to the solar panel array voltage. It is noted that the DAB 34 voltage setting can be dynamically changed in real time or near real time as the solar panel voltage changes.

At block 76, the controller 36 determines whether the battery pack 24 SOC is below a selected SOC threshold. If so, at block 77, charge may be transferred from the battery pack 24 to the DAB 34 if desired (e.g., if the DAB 34 SOC is low).

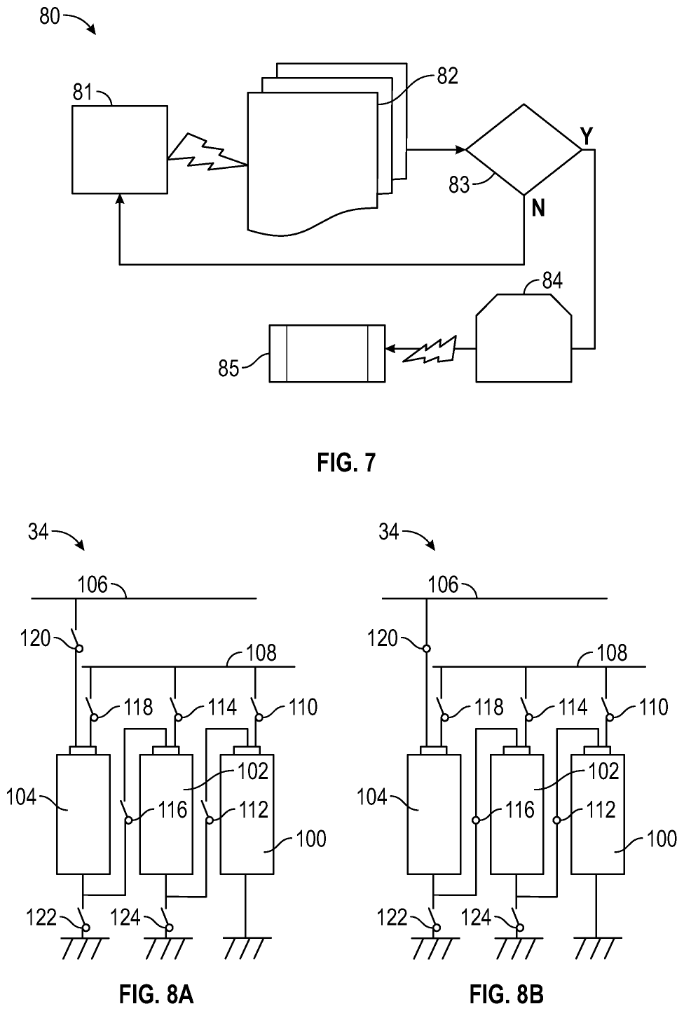

FIG. 7 illustrates embodiments of a method 80 of controlling transfer of charge from a solar energy conversion device. Aspects of the method 80 may be performed by a processor or processors disposed in a vehicle. For example, the method is discussed as being performed by the controller 36, but is not so limited, as the method 80 may be performed by the computer system or any other suitable processing device or system, or combination of processing devices (e.g., the ECU 50 or the computer system 40).

The method 80 includes a number of steps or stages represented by blocks 81-85. The method 80 is not limited to the number or order of steps therein, as some steps represented by blocks 81-85 may be performed in a different order than that described below, or fewer than all of the steps may be performed.

The method 80 may be performed as part of an overall monitoring and charge transfer method, such as the method 70. For example, the method 80 may be performed as part of blocks 74 and 75 of the method 70.

At block 81, parameters of the solar panel arrays 48 are measured. The parameters may include solar panel array voltage (V), current (I) and power (P).

At block 82, the solar panel array voltage is compared to the DAB 34 voltage settings, and the voltage setting that is closest to the solar panel array voltage is selected by controlling appropriate switches. For example, the DAB 34 is configured to have two voltage settings, including a 12V setting and a 24V setting.

Upon selection of the desired setting, current from the solar panel array 48 flows to the DAB 34 and charges the DAB 34.

At block 83, the DAB 34 is monitored by measuring the DAB 34 SOC during the charging process. The solar panel array parameters are repeatedly measured until the DAB 34 is fully charged, or if conditions change such that the solar panel output is no longer sufficient.

At block 84, upon determining that the DAB 34 is fully charged (or if conditions change as noted above), the DAB 34 is reset as necessary to put the DAB 34 to the highest available voltage setting. At block 85, the DAB 34 may then be used to charge the battery pack 24.

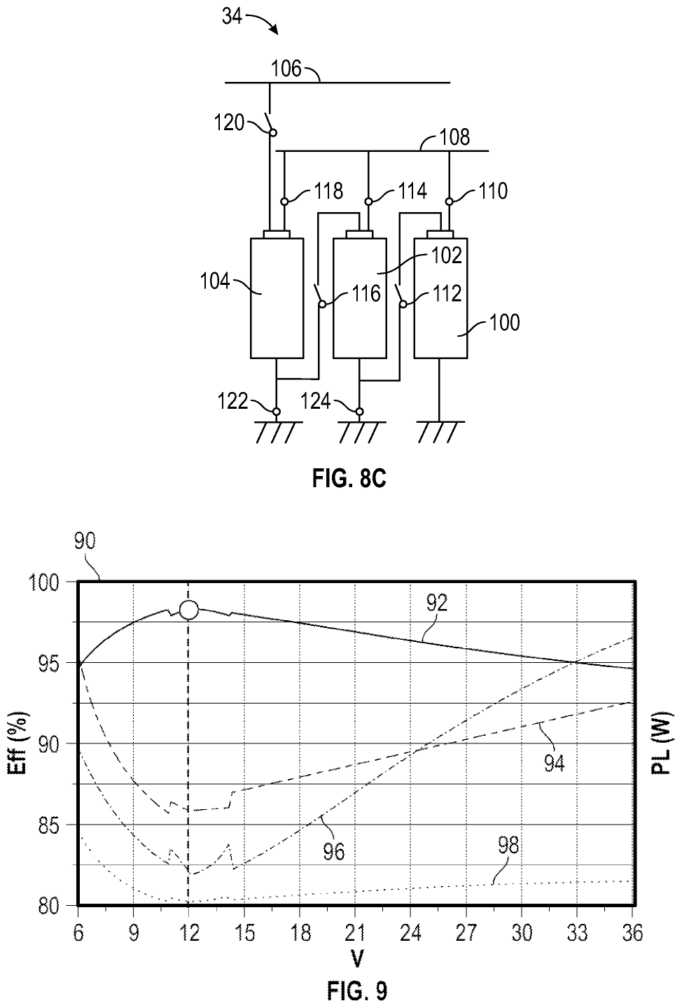

FIGS. 8A-8C depict an embodiment of the DAB 34 and illustrate using switches therein to put the DAB 34 into various operating states. The DAB 34 includes a plurality of battery cells 100, 102 and 104, which are connected in series to a high voltage (HV) bus 106. The battery cells 100, 102 and 104 are also connected in parallel to a low voltage (LV) bus 108. The DAB 34 as shown includes three cells, and each cell is a 12 V cell. However, the DAB 34 is not limited to any specific number of cells, and the cells may each have any suitable voltage rating.

The cells 100, 102 and 104 are connected to various switches for putting the DAB 34 into different operating modes. The switches may be FETs or other suitable type. The cell 100 is connected to the LV bus 108 via a switch 110 and the cell 102 is connected to the LV bus 108 via a switch 112. The cell 102 is connected to the LV bus 108 via a switch 114 and the cell 104 is connected to the LV bus 108 via a switch 116. The cell 104 is connected to the LV bus 108 via switch 118 and the HV bus via a switch 120. Switches 122 and 124 selectively connect the cells 102 and 104 to ground.

FIG. 8A shows the DAB 34 when the DAB 34 is at rest or in a non-operating state. In this state, all of the switches are open.

FIG. 8B shows the DAB 34 as configured to output a high voltage (e.g., 36V). In the high voltage state, the switches 112, 116 and 120 are closed, putting all of the cells in series with the HV bus 106. The remaining switches are open. For example, if the cells are 12V cells, the DAB 34 outputs a voltage of 36V through the HV bus 106.

It is noted that the DAB 34 can be put into an intermediate voltage state by closing fewer than all of the cells 100, 102 and 104. For example, the DAB 34 can be configured to output 24V by closing switches 120 and 116, and leaving the remaining switches open.

FIG. 8C shows the DAB 34 as configured to output a low voltage (e.g., 12V). In the low voltage state, the switches 110, 114 and 118 are closed, putting all of the cells in parallel with the LV bus 108. Ground switches 122 and 124 are also closed, and the remaining switches are open. For example, if the cells are 12V cells, the DAB 34 outputs a voltage of 12V through the LV bus 108.

As discussed above, embodiments described herein increase the charging efficiency when a vehicle's battery assembly is charged using solar energy conversion devices. FIG. 9 is a graph 90 that demonstrates the increase in efficiency and reduction of power loss in the low voltage DC-DC converter 58 that occurs due to a reduction in the voltage difference between the solar panel array 48 voltage and the DC-DC converter 58 output voltage.

The graph 90 shows charge efficiency (% of solar panel charge) for a DAB 34 having a 12V voltage setting (12 V output voltage) and a 6 A current output. The charge efficiency (Eff) is a function of solar panel input voltage (in Volts) and is shown by curve 92.

The graph 90 also shows power loss (in Watts) of DC-DC converter components. The total power loss (PL) of the DC-DC converter switches is shown by curve 94, inductor loss is shown by curve 96, and shunt loss is shown by curve 98. As can be seen, the charging efficiency increases, and the power loss reduces, as the input voltage from the solar panel arrays 48 gets closer to the DAB 34 output voltage setting. Thus, by controlling the DAB 34 as discussed herein to reduce the difference between the input voltage and the DAB voltage, charge efficiency can be significantly increased and power loss reduced.

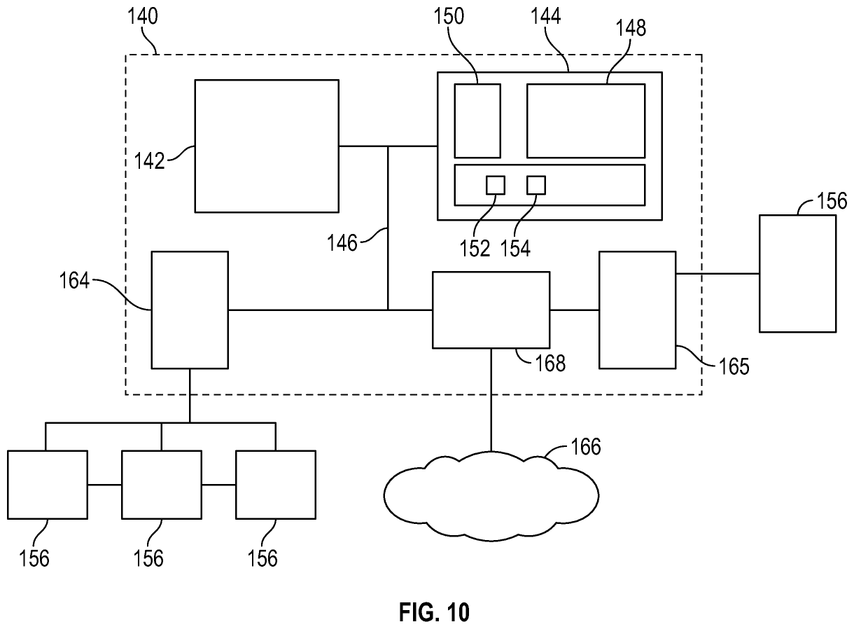

FIG. 10 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included for performing functions related to monitoring system components, and a module 154 may be included to perform functions related to controlling charging operations as discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A solar energy charging system of a vehicle, comprising:
a dynamically adjustable battery (DAB) configured to be connected to a solar energy conversion device and charged by the solar energy conversion device, the DAB controllable to adjust an output voltage of the DAB to one of a plurality of output voltages, the DAB configured to supply electrical power generated by the solar energy conversion device to a vehicle battery assembly; and
a controller configured to detect an input voltage to the solar energy conversion device, select an output voltage of the DAB based on the input voltage, and control the DAB to provide the selected output voltage to a high voltage DC-DC converter to charge the battery assembly.

2. The system of claim 1, wherein the DAB includes a plurality of controllable switches, and the controller is configured to operate the switches to cause the DAB to output the selected voltage.

3. The system of claim 1, wherein each voltage of the plurality of output voltages is less than a vehicle battery assembly voltage.

4. The system of claim 1, further comprising a low voltage DC-DC converter configured to convert the input voltage to a low voltage value, wherein the controller is configured to select the output voltage based on the low voltage value.

5. The system of claim 1, wherein the selected output voltage has a value that is closest to a value of the input voltage.

6. The system of claim 1, wherein the controller is configured to measure a state of charge of the DAB, receive solar information indicative of a level of solar intensity, and select the output voltage based on the state of charge being below a threshold state of charge value and the level of solar intensity being at or above an intensity threshold value.

7. The system of claim 6, wherein the solar information includes at least one of a measured input voltage from the solar energy conversion device, a measured solar intensity, and an estimated solar intensity derived from climate and weather information.

8. The system of claim 1, wherein the controller is configured to measure a state of charge of the DAB, and receive solar information indicative of a level of solar intensity, and based on the state of charge being below a threshold state of charge value and the level of solar intensity being below an intensity threshold value, connect the DAB to the vehicle battery assembly to cause the vehicle battery assembly to charge the DAB.

9. The system of claim 1, wherein the controller is configured to control the DAB to supply power to one or more additional vehicle components.

10. A method of transferring charge, comprising:
connecting a dynamically adjustable battery (DAB) to a solar energy conversion device and to a vehicle battery assembly, the DAB configured to be charged by the solar energy conversion device, the DAB controllable to adjust an output voltage of the DAB to one of a plurality of output voltages, device;
detecting, by a controller, an input voltage to the solar energy conversion selecting an output voltage of the DAB based on the input voltage; and
controlling the DAB to provide the selected output voltage to a high voltage DC-DC converter to charge the battery assembly.

11. The method of claim 10, wherein each voltage of the plurality of output voltages is less than a vehicle battery assembly voltage.

12. The method of claim 10, further comprising supplying charge to the DAB from the solar energy conversion device.

13. The method of claim 12, wherein supplying the charge includes converting the input voltage by a low voltage DC-DC converter to a low voltage value, and the output voltage is selected based on the low voltage value.

14. The method of claim 10, wherein the selected output voltage has a value that is closest to a value of the input voltage.

15. The method of claim 10, further comprising measuring a state of charge of the DAB and receiving solar information indicative of a level of solar intensity, wherein the output voltage is selected based on the state of charge being below a threshold state of charge value and the level of solar intensity being at or above an intensity threshold value.

16. The method of claim 15, wherein the solar information includes at least one of a measured input voltage from the solar energy conversion device, a measured solar intensity, and an estimated solar intensity derived from climate and weather information.

17. The method of claim 15, further comprising, based on the state of charge being below a threshold state of charge value and the level of solar intensity being below an intensity threshold value, connecting the DAB to the vehicle battery assembly and causing the vehicle battery assembly to charge the DAB.

18. A vehicle system, comprising:
a solar energy conversion device;
a battery assembly; and
a solar energy charging system including:
a dynamically adjustable battery (DAB) configured to be connected to a solar energy conversion device and charged by the solar energy conversion device, the DAB controllable to adjust an output voltage of the DAB to one of a plurality of output voltages, the DAB configured to supply electrical power generated by the solar energy conversion device to a vehicle battery assembly; and
a controller configured to detect an input voltage to the solar energy conversion device, select an output voltage of the DAB based on the input voltage, and control the DAB to provide the selected output voltage to a high voltage DC-DC converter to charge the battery assembly.

19. The vehicle system of claim 18, wherein the solar energy charging system further includes a low voltage DC-DC converter configured to convert the input voltage to a low voltage value, wherein the controller is configured to select the output voltage based on the low voltage value.

20. The vehicle system of claim 19, wherein the selected output voltage has a value that is closest to a value of the input voltage.
